(19) United States
(12) Patent Application Publication
(10) Pub. No.: US 2021/0123290 A1
(43) Pub. Date: Apr. 29, 2021

(54) EXTERIOR DOOR INSTALLATION BRACKET

(71) Applicant: David Jantzi, Poole (CA)

(72) Inventor: David Jantzi, Poole (CA)

(21) Appl. No.: 16/667,853

(22) Filed: Oct. 29, 2019

(51) Int. Cl. E06B 1/60; E06B 7/28

(52) U.S. Cl. CPC E06B 1/603; E06B 7/28

(57) ABSTRACT

An illustrated view of an exemplary exterior door installation bracket for installing an exterior door is presented. The exterior door installation bracket is useful for holding the exterior door firm in a rough opening prior to shimming the exterior door. The exterior door installation bracket provides for opening the door prior to shimming the exterior door and frame are equally spaced and that the hinges are level. Therefore, the exterior door installation bracket increases productivity by reducing effort and time in installing the exterior door for those learning to hang a door, a do-it yourselfer and the professional. The bracket has a plate and a support plate. The support plate coupled to the plate and placed between a door frame and a rough opening. The bracket having holes to be coupled to the bracket to the door frame and a slot to couple the bracket to a drywall wall. The bracket also has a stub handle to ease the maneuvering of the bracket.

### FIELD OF THE INVENTION

This invention relates to exterior doors. More particularly, it relates to an device to improve installation of exterior doors.

### BACKGROUND

A door is a panel that covers an opening in a building, room or vehicle. Doors are usually made of a hard, semi-permeable, and hard-to-break substance (such as wood or metal), but sometimes consisting of a hard frame into which windows or screens have been fitted. Doors are often attached by hinges to a frame. Doors make ingress into or egress from a budding, room, or vehicle easier to manage. The panel may be moved in various ways (at angles away from the frame, by sliding on a plane parallel to the frame, by folding in angles on a parallel plane, or by spinning along an axis at the center of the frame) to allow or prevent ingress or egress. In most cases, a door's interior matches its exterior side. But in other cases (e.g., a vehicle door) the two sides are radically different.

Often doors have locking mechanisms to ensure that only some people can open them. Doors can have devices such as knockers or doorbells by which people outside can announce theft presence and summon someone either to open the door for them or give permission to open and enter. Apart from providing access into and out of a space, doors can have the secondary functions of ensuring privacy by preventing unwanted attention from outsiders, of separating areas with different functions, of allowing light to pass into and out of a space, of controlling ventilation or air drafts so that interiors may be more effectively heated or cooled, of dampening noise, and of blocking the spread of fire.

Doors may have aesthetic, symbolic, ritualistic purposes. To be given the key to a door can signify a change in status from outsider to insider. Doors and doorways frequently appear in literature and the arts with metaphorical or allegorical import as a portent of change.

To install an exterior door, the following steps are necessary:

1) Create rough opening around frame. You need to measure the width between the side jambs, the head jamb to the seal under the old threshold, as well as the thickness of the wall. The rough opening needs to be a minimum of 1 inch (2.54 cm) wider and taller than the outside of the door system you'll be installing.

2) Make sure everything is level. While you're working you should periodically check with your leveler that everything is staying level. If things aren't level the door may end up being tilted or frame, which will cause problems later on.

3) insert door into opening. Place the bottom of the door first, tilting the top out toward you, then slide the door into place. It's best to work from the outside of the house when you're inserting the door into the opening.

4) Shim the rest of the door-frame. Place shims on the hinge side of the door, behind any points where hinges will be attached to the door frame.

5) Secure door temporarily. After you've made all of the necessary adjustments, secure the door temporarily, using 16 d finishing nails. Lightly drive the nails through the hinge jamb, near where the hinges will be installed.

6) Test the swing of the door. It should open and close smoothly, Sometimes pre-hung doors will have an adjustable sill, which can be useful it the door isn't quite adjusted perfectly.

7) Secure door-jambs. Drive 3-inch (7.62 cm) screws through the shims at the hinge sites on the hinge jamb. Secure the remaining jambs all the way around the door, always driving the screws or nails (whatever is suggested by the manufacturer) through the shims.

8) Install insulation. Finish the job by installing loosely packed, fiberglass insulation around the edges of the door frame. Install interior trim, following the manufacturer's instructions. Apply paintable caulk along all of the joints and intersections of the trim and the brick-mold.

Each of the steps may have serious problems causing issues with the door or security or comfort in the house. In light of the foregoing, there is a need for a device to help ease and make efficient the hanging and installation of an exterior door.

### BRIEF DESCRIPTION OF THE DRAWINGS

FIG. 1A is an illustrated view of an exemplary exterior door installation bracket.

FIG. 1B is an illustrated view of an alternative embodiment of the exemplary exterior door installation bracket shown in FIG. 1A.

FIG. 2 is an illustrated view of a use of the exemplary exterior door installation bracket shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

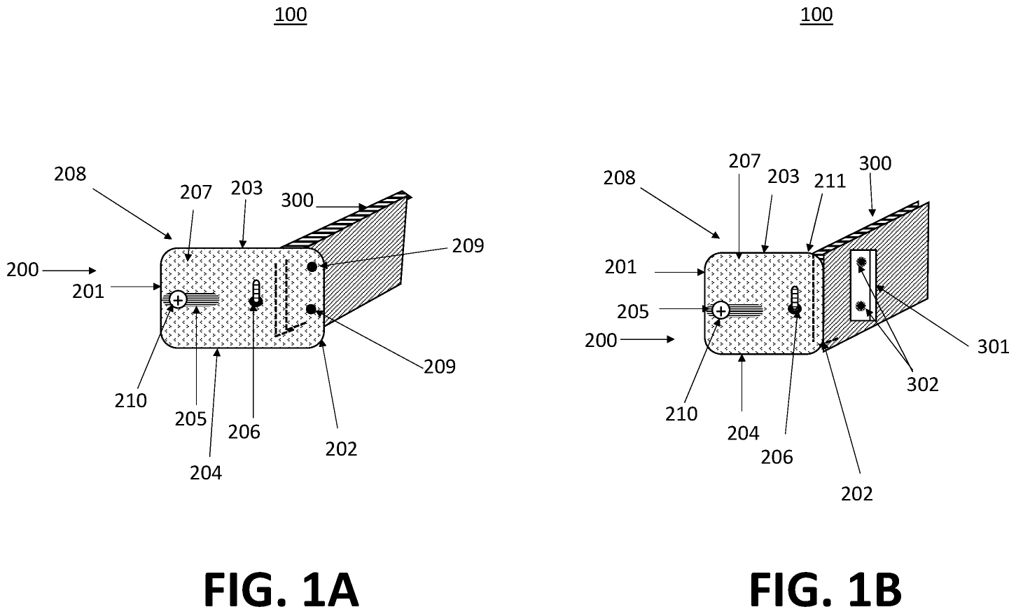

Referring to FIG. 1A and FIG. 1B, an illustrated view of an exemplary exterior door installation bracket 100 for installing an exterior door is presented. The exterior door installation bracket 100 is useful for holding the exterior door firm in a rough opening prior to shimming the exterior door. The exterior door installation bracket 100 provides for opening the door prior to shimming the exterior door and frame are equally spaced and that the hinges are level. Therefore, the exterior door installation bracket 100 increases productivity by reducing effort and time in installing the exterior door for those learning to hang a door, a do-it yourselfer and the professional.

The exterior door installation bracket 100 has a plate 200 and a support plate 300. The support plate 300 preferably has a length of two (2) inches, however other lengths are hereby contemplated, including, but not limited to, one and one-half (1.5) inches, three (3) inches, etc. The support plate 300 preferably has a height of two (2) inches, however other heights are hereby contemplated, including, but not limited to, one and one-half (1.5) inches, three (3) inches, etc. The support plate 300 preferably has a width of one-half (0.5) inch, however other widths are hereby contemplated, including, but not limited to, one-quarter (0.25) inch, three-quarter (0.75) inch, etc. The support plate 300 preferably is made of a metal material, such as steel, aluminum, etc., however other materials are hereby contemplated, including, but not limited to, wood, plastic, poly-vinyl chloride (PVC), etc. The support plate 300 is useful for providing a support between the exterior door and a roughed in opening. The support plate 300 is preferably square in shape, however other shapes are hereby contemplated, including, but not limited to, rectangular, oblong, trapezoidal, etc.

The plate 200 has a first end 201, a second end 202, a top 203, a bottom 204, a slot 205, a stub handle 206, a front 207, a back 208 and a plurality of coupling holes 209.

The plate 200 preferably has a length of two (2) inches, however other lengths are hereby contemplated, including, but not limited to, one and one-half (1.5) inches, three (3) inches, etc. The plate 200 preferably has a height of two (2) inches, however other heights are hereby contemplated, including, but not limited to, one and one-half (1.5) inches, three (3) inches, etc. The plate 200 preferably has a width of one-half (0.5) inch, however other widths are hereby contemplated, including, but not limited to, one-quarter (0.25) inch, three-quarter (0.75) inch, etc. The plate 200 preferably is made of a metal material, such as steel, aluminum, etc., however other materials are hereby contemplated, including, but not limited to, wood, plastic, poly-vinyl chloride (PVC), etc. The plate 200 is useful for providing a spacing between the exterior door and a roughed in opening. The plate 200 is preferably square in shape, however other shapes are hereby contemplated, including, but not limited to, rectangular, oblong, trapezoidal, etc. The plate 200 preferably has rounded corners.

The support plate 300 is coupled to the back 208 of the plate 200 approximately five-eights (⅝) inches from the second end 202 of the plate 200 by a first coupling device (not shown), however other positions for the coupling hare hereby contemplated, including, but not limited to, one-half (0.5) inch, three-quarter (0.75) inch, etc. The first coupling device is preferably a weld, however other coupling devices are hereby contemplated, including, but not limited to, screws, adhesives, a mold, etc.

The plurality of holes 209 of the plate 200 are coupled to the door frame by a plurality of coupling devices 210. The coupling devices 210 are preferably screws, however other coupling devices are hereby contemplated, including, but not limited to, nails, adhesive material, Velcro, etc.

In FIG. 1B, the support plate 300 is coupled at the second end 202 of the plate 200. A coupling block 301 has a plurality of coupling holes 302. The coupling block 301 is coupled to the support plate 300 at approximately one (1) inch distance from the second end 202 of the plate 200 thus providing an offset. However, other distances from the second end 202 is hereby contemplated, including, but not limited to, one and one-half (1.5) inches, two and one-half (2.5) inches, etc.

The plurality of holes 302 of the coupling block 302 of the support plate 300 are coupled to the door frame by a plurality of third coupling devices (not shown). The third coupling devices are preferably screws, however other coupling devices are hereby contemplated, including, but not limited to, nails, adhesive material, Velcro, etc.

The slot 205 of the plate 200 is preferably five-eights (⅝) inch in length, however other lengths are hereby contemplated, including, but not limited to, one-half (½) inch, three-quarter (¾) inch, etc. The slot 205 of the plate 200 is configured significantly near the first end 201 of the plate 200. The slot 205 is coupled to drywall of an interior wall by a fourth coupling device 210, such as a screw or other and secures the door to the. The fourth coupling devices 210 are preferably screws, however other coupling devices are hereby contemplated, including, but not limited to, nails, adhesive material, Velcro, etc.

The stub handle 206 of the plate 200 is configured between a second end 211 of the slot 205 of the plate 200 and significantly near the coupling position 202 of the plate 200 and the support plate 300. The stub hand 206 of the plate 200 preferably has a length of one (1) inch, however other lengths are hereby contemplated, including, but not limited to, one-half (0.5) inch, two (2) inches, etc. The stub handle 206 is preferably made of a metal material, such as steel, aluminum, etc., however other materials are hereby contemplated, including, but not limited to, plastic, wood, poly-vinyl chloride (PVC).

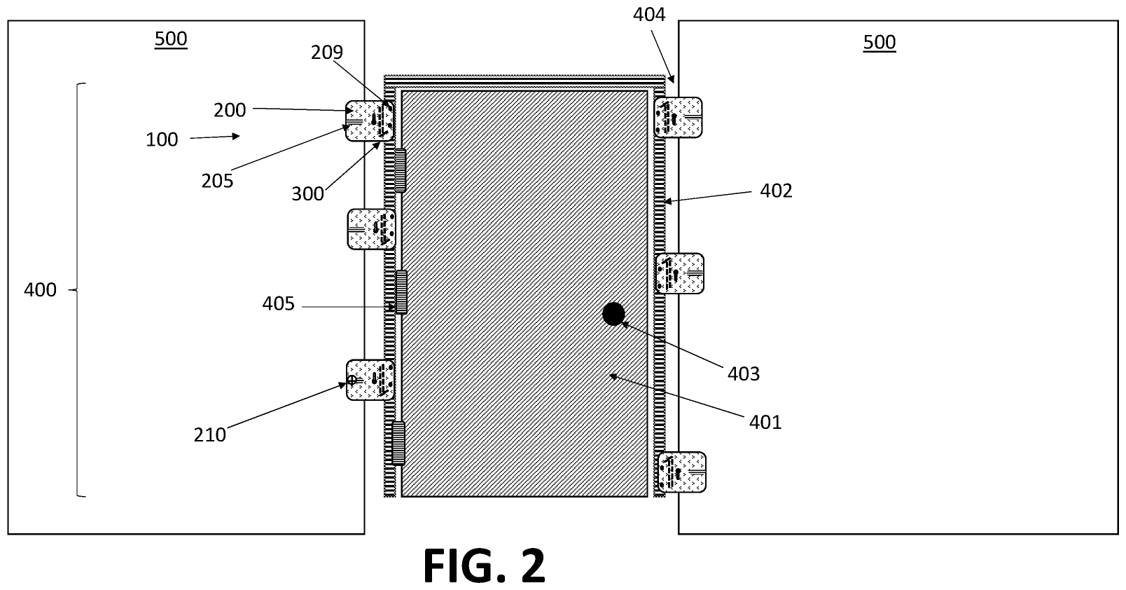

Moving now to FIG. 2, the exterior door installation bracket 100 shown in FIG. 1A is coupled to an exterior door 400. Preferably there are no greater than six (6) exterior door installation brackets 100, however other numbers of exterior door installation brackets 100 are hereby contemplated, including, but not limited to, one (1), four (4), etc.

The door 400 has a panel 401, a door frame 402 and a door knob 403.

The support plate 300 of the exterior door installation bracket 100 is configured between an edge 404 of the door frame 402, a wall 500 and firmly against the door frame 402.

The plate 200 of the exterior door installation bracket 100 is coupled to the wall 500 by inserting a coupling device 210 into the slot 205 of the plate 200. The coupling device 210 is configured to be coupled into the wall 500 such that the plate 200 of the exterior door installation bracket 100 is securely coupled to the wall 500.

The plate 200 is coupled to the door frame 402 of the door 400. The coupling device 210 is inserted into the each of the plurality of coupling holes 209 of the plate 200. The coupling devices 210 are coupled into the door frame 402.

The knob 403 of the door 400 can then be turned to allow the door 400 to be open and closed such and thereby checking a swinging of the door 400 and verifying whether one or more hinges 405 of the door 400 are configured to be level.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An exterior door installation bracket, the bracket comprising:
a plate, the plate consisting of:
a first end, a second end, a top, a bottom, a face and a back;
a plurality of coupling devices;
a plurality of coupling holes, the coupling holes for coupling the bracket to a door frame, wherein the plurality of holes having a second of the coupling devices;
a slot, the slot for coupling the plate to a wall, wherein the slot being for receiving a first of the coupling devices, and wherein the slot being configured to be significantly near the first end of the plate;
a stub handle, the stub handle being coupled to the plate significantly between the slot and the second end of the plate; and
a support plate, the support plate coupled to the second end of the plate by the first of the coupling devices.

2. The bracket of claim 1, wherein the plate being two (2) inches in length.

3. The bracket of claim 1, wherein the support plate being two (2) inches in length.

4. The bracket of claim 1, wherein the plate being two (2) inches in height.

5. The bracket of claim 1, wherein the support plate being two (2) inches in height.

6. The bracket of claim 1, wherein the plate being made of a metal material.

7. The bracket of claim 6, wherein the metal material being steel.

8. The bracket of claim 1, wherein the support plate being made of a metal material.

9. The bracket of claim 1, wherein the plate being made of a plastic material.

10. The bracket of claim 1, wherein the plate being made of poly-vinyl chloride (PVC).

11. The bracket of claim 1, wherein the support plate being made of a plastic material.

12. The bracket of claim 1, wherein the support plate being made of poly-vinyl chloride (PVC).

13. The bracket of claim 1, wherein the first of the coupling devices being a weld.

14. The bracket of claim 1, wherein the first of the coupling devices being made of a mold.

15. The bracket of claim 1, wherein the second of the coupling devices being a screw.

16. The bracket of claim 1, wherein the number of brackets being no greater than six (6).

17. An exterior door installation bracket, the bracket consisting of:
a plate, the plate consisting of:
a first end, a second end, a top, a bottom, a face and a back;
a plurality of coupling devices;
a plurality of coupling holes, the coupling holes for coupling the bracket to a door frame, wherein the plurality of holes having of a second of the coupling devices;
a slot, the slot for coupling the plate to a wall, wherein the slot being for receiving a first of the coupling devices, and wherein the slot being configured to be significantly near the first end of the plate;
a stub handle, the stub handle being coupled to the plate significantly between the slot and the second end of the plate; and
a support plate, the support plate coupled to the second end of the plate by the first coupling device;
wherein the plate being two (2) inches in length;
wherein the support plate being two (2) inches in length;
wherein the plate being two (2) inches in height;
wherein the support plate being two (2) inches in height;
wherein the plate being made of a metal material;
wherein the metal material being steel;
wherein the support plate being made of a metal material;
wherein the first of the coupling devices being a weld;
wherein the first of the coupling devices being made of a mold;
wherein the second of the coupling devices being a screw; and
wherein the number of brackets being no greater than six (6).

18. An exterior door installation bracket, the bracket consisting of:
a plate, the plate consisting of:
a first end, a second end, a top, a bottom, a face and a back;
a plurality of coupling devices;
a plurality of coupling holes, the coupling holes for coupling the bracket to a door frame, wherein the plurality of holes having a plurality a second of the coupling devices;
a slot, the slot for coupling the plate to a wall, wherein the slot being for receiving a first of the coupling devices, and wherein the slot being configured to be significantly near the first end of the plate;
a stub handle, the stub handle being coupled to the plate significantly between the slot and the second end of the plate; and
a support plate, the support plate coupled to the second end of the plate by the first of the coupling devices;
wherein the plate being two (2) inches in length;
wherein the support plate being two (2) inches in length;
wherein the plate being two (2) inches in height;
wherein the support plate being two (2) inches in height;
wherein the plate being made of a plastic material;
wherein the support plate being made of a plastic material;
wherein the first of the coupling devices being a weld;
wherein the first of the coupling devices being made of a mold;
wherein the second of the coupling devices being a screw; and
wherein the number of brackets being no greater than six (6).

19. An exterior door installation bracket, the bracket consisting of:
a plate, the plate consisting of:
a first end, a second end, a top, a bottom, a face and a back;
a plurality of coupling devices;
a plurality of coupling holes, the coupling holes for coupling the bracket to a door frame, wherein the plurality of holes having a second of the coupling devices;
a slot, the slot for coupling the plate to a wall, wherein the slot being for receiving the first of the coupling devices, and wherein the slot being configured to be significantly near the first end of the plate;
a stub handle, the stub handle being coupled to the plate significantly between the slot and the second end of the plate; and
a support plate, the support plate coupled to the second end of the plate by a first coupling device;
wherein the plate being two (2) inches in length;
wherein the plate being two (2) inches in height;
wherein the support plate being two (2) inches in height;
wherein the plate being made of poly-vinyl chloride (PVC);
wherein the support plate being made of poly-vinyl chloride (PVC);
wherein the first of the coupling devices being a weld;
wherein the first of the coupling devices being made of a mold;
wherein the second of the coupling devices being a screw; and
wherein the number of brackets being no greater than six (6).
